(19) United States
(12) Patent Application Publication
(10) Pub. No.: US 2003/0109399 A1
(43) Pub. Date: Jun. 12, 2003

(54) Cleaning compositions containing nanolatex, peroxygen bleach and/or fluorinated compounds and method for cleaning carpets and other materials

(75) Inventors: Oreste Todini, Rome (IT); Stefano Resta, Rome (IT); Marco DeSantis, Rome (IT); Stefano Scialla, Rome (IT); Cedric Willy Geffroy, Paris (FR); Marie-Pierre Catherine Labeau, Paris (FR); Eric Aubay, Perreux sure Marne (FR)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/192,349

(22) Filed: Jul. 10, 2002

Related U.S. Application Data
(60) Provisional application No. 60/304,684, filed on Jul. 11, 2001.

(51) Int. Cl. C11D 17/00

(52) U.S. Cl. 510/278; 510/375; 510/475; 510/412

(57) ABSTRACT

Cleaning compositions and methods for cleaning carpets and other materials are disclosed. The cleaning compositions contain nanolatexes and the methods for cleaning carpets and other materials use such compositions. The compositions may also contain a source of peroxygen bleach and/or a fluorinated compound.

This application claims the benefit of U.S. Provisional Application No. 60/304,684, filed Jul. 11, 2001.

### FIELD OF THE INVENTION

The present invention relates to cleaning compositions and methods for cleaning carpets, and other materials. More particularly, the present invention relates to cleaning compositions that contain nanolatexes and methods for cleaning carpets and other materials which use such compositions.

### BACKGROUND OF THE INVENTION

Polymer solutions or dispersions have been proposed for carpet cleaning. For example, PCT Publication WO9407980 describes a carpet shampoo composition containing polymers that become water dispersible or water soluble upon neutralization with an alkaline compound, in combination with a specific type of wax and silicone betaine polymers. Aqueous compositions comprising a sulfonated copolyester are described in PCT Publication WO0138467. PCT Publication WO0026330 describes the use of vinyl methyl ether-maleic acid copolymers for carpet cleaning. PCT Publication WO9615308 describes the use of soil suspending polycarboxylate or polyamine polymers for improving the particulate soil removal performance in carpet cleaning. U.S. Pat. No. 4,203,859 describes the use of dispersed polymer solubilized by ammonia or volatile amines addition in combination with polyvalent cations for the modification of carpet shampoo composition or the finishing of carpet fibers. Other patents are directed to the use of polymeric compositions for other purposes relating to carpets (see, for example, U.S. Pat. No. 4,081,383 directed to an acrylic polymer containing epoxy units for use as a permanent finish on the carpet, and U.S. Pat. No. 5,478,881 for latexes used as a binder in carpet coating compositions). However, unless the polymer is used for one of these other purposes unrelated to cleaning, the polymer material must be easily removable by vacuuming.

Polish Patent Publication 172084 is directed to a composition for cleaning rugs, carpets, upholstery and similar textile materials that comprises an aqueous dispersion containing fine particles of an acrylic polymer or styrene-acrylic copolymer having a minimal film-forming temperature of 60 degrees, and 5-50 weight parts of a surface active agent. South African Patent Publication 6704138 is directed to a composition for application to a fiber or fiber assembly which comprises a stable shampoo concentrate, a stabilized aqueous non-film forming dispersion of a styrene polymer, and water with all of the particles of the dispersed polymer having a diameter of 0.01 to 2.0 microns.

There is a desire to incorporate increasing levels of polymer into such carpet cleaning compositions to improve soil removal. However, if the concentration of the polymer is too high (in one non-limiting example, above 7%), the composition will leave a residue behind, even after vacuuming. Such a residue can cause several negative effects, including whitening of the carpet (since the polymeric material is generally white in color if the polymer is of a non-film forming type), or change in the color of the carpet, and harshness of feel of the carpet. It has also been found that providing a composition with too high a level of sufactant can lead to problems. Increasing the level of surfactant can lower the minimal film forming temperature of the composition, resulting in the formation of films which are more difficult to remove by vacuuming.

Thus, a need exists for a composition which forms polymer aggregates on the carpet surface which are easily removed by vacuuming. If the composition is not removed sufficiently from the carpet, it may tend to increase the tendency for the carpet to retain future soils.

Therefore, it is an object of the present invention to provide compositions and methods for the cleaning of carpets (among other materials) that comprise liquid nanolatex containing compositions which, in the case of carpets, upon spraying on the carpet and let to dry, form polymer aggregates that are easy to vacuum.

These and other objects of the present invention will become more readily apparent when considered in reference to the following description and when taken in conjunction with the accompanying drawings.

### SUMMARY OF THE INVENTION

This invention relates to compositions and methods for cleaning carpets and other materials. More particularly, the present invention relates to water based cleaning compositions that contain nanolatexes and methods for cleaning carpets and other materials which use such compositions.

The cleaning compositions of the present invention preferably comprise stable water suspensions of nanolatexes (which may be referred to as “nanolatex materials” or “nanolatex polymers”).

Preferred monomers comprising the nanolatex include, but are not limited to: metacrylic acid and its salts, esters of methacrylic acid, preferably methyl and butyl methacrylate, diMEG, styrene, styrene sulfonate, and 1-Propanesulfonic acid, 2-methyl-2-[(1-oxo-2-propenyl) amino]-(9CI) (also referred to herein as “AMPS”).

The present invention is also directed to a method of cleaning carpets and other materials. In the case of carpet cleaning, the method comprises the steps of:

(a) locating the carpet;

(b) applying a carpet cleaning composition to at least a portion of said carpet, said carpet cleaning composition comprising at least a nanolatex polymer and water; and

(c) allowing the carpet cleaning composition to dry.

The method may also comprise a step of vacuuming the carpet. Steps (a) to (c) can be repeated one or more times before vacuuming.

Preferably, in the case of carpet cleaning, the composition is applied by a sprayer, more preferably by a trigger or pump sprayer and even more preferably by an electrical sprayer, wherein the electrical sprayer can be battery or power operated. The composition can, however, be applied in any manner known in the art to carpets or other materials or surfaces.

All percentages, ratios and proportions herein are on a weight basis based on a neat product unless otherwise indicated.

### DETAILED DESCRIPTION OF THE INVENTION

This invention relates to cleaning compositions and methods for cleaning surfaces such as carpets. More particularly, the present invention relates to cleaning compositions that contain nanolatexes and methods for cleaning carpets and other materials which use such compositions.

### Carpet Cleaning Compositions

A first embodiment of the invention is a carpet cleaning composition and a process for cleaning rugs and carpets. This composition is particularly useful for cleaning carpets and rugs comprised of synthetic fibers, more particularly polyamid or polyester fibers. This embodiment is not intended to be limiting and one skill in the art will understand that the process can be applied both synthetic and natural fibers such as wool, linen, hemp or silk.

### Nanolatex

The term “nanolatex”, as used herein, refers to latex materials that are in the form of nanoparticles (particles having an average particle size as measured using light scattering techniques of less than or equal to about 500 nanometers). In preferred embodiments, the nanolatexes have a molecular weight greater than or equal to about 20,000, or any molecular weight greater than 20,000, including, but not limited to greater than or equal to about 200,000.

The nanolatex polymer (P), in at least some embodiments, can comprise:

hydrophobic monomer “units” (N) that are uncharged or non-ionizable at the pH of the composition in normal conditions of use;

optionally at least one hydrophilic monomer unit chosen from the group consisting of:

(F1) cationic or cationizable monomers at the pH of said composition in normal conditions of use;

(F2) amphoteric monomers at the pH of said composition in normal conditions of use;

(F3) anionic or anionizable monomers at the pH of said composition in normal conditions of use;

(F4) uncharged or non-ionizable hydrophilic monomers at the pH of said composition in normal conditions of use;

any combination thereof; and

optionally, at least one reticulating unit (R).

Examples of substances from which monomer units (N) and (F) may be derived, include, but are not limited to: α-β monoethylenically unsaturated monomers and the monomer units (R) may be derived from diethylenically unsaturated monomers. In other non-limiting embodiments, the hydrophobic units (N) may be derived from vinylaromatic monomers, α-β fatty acid alkylester monoethylenically unsaturated, vinylesters or allyl of saturated carboxylic acids, or α-β monoethylenically unsaturated nitrites.

Examples of substances from which the cationic or cationizable hydrophilic units (F1) may be derived, include, but are not limited to: N,N (dialkylaminoalkyl) amides of α-β carboxylic acids monoethylenically unsaturated, α-β aminoesters monoethylenically unsaturated, or monomers which are precursors of primary amine functions by hydrolysis.

The amphoteric hydrophilic units (F2) may be derived in a number of manners, including, but not limited to: from N,N-dimethyl-N-methacryloyloxyethyl-N-(3-sulfopropyl) sulfobetaine ammonium, from N,N-dimethyl-N-(2-methacrylamidoethyl)-N-(3-sulfopropyl) betaine ammonium, from 1-vinyl-3-(3-sulfopropyl) betaine imidazolidium, from 1-(3-sulfopropyl)-2-vinylpyridinium betaine, and also from the reaction of quaternization of N(dialkylaminoalkyl) amides of α-β carboxylic acids ethylenically unsaturated or from α-β aminoesters monoethylenically unsaturated by a alkali metal chloroacetate or sultone propane chloroacetate.

The hydrophilic anionic or anionizable (F3) units may be derived in a number of manners, including, but not limited to: from α-β monomers monoethylenically unsaturated having at least one carboxylic function, from 60 -β monomers monoethylenically unsaturated having at least one sulfate or sulfonate function, α-β monomers monoethylenically unsaturated having at least one phosphonate or phosphate function, and their hydrosoluble salts, from α-β monomers monoethylenically unsaturated being precursors of carboxylate function(s) by hydrolysis.

The hydrophilic uncharged or non-oinizable (F4) units may be derived in a number of manners, including, but not limited to: from α-β hydroxyalkylester acids monoethylenically unsaturated, from α-β amide acids monoethylenically unsaturated, from α-β monomers ethylenically unsaturated carrying a hydrosoluble polyoxyalkylened segment, from α-β monomers monoethylenically unsaturated being precursors of vinylic alcohol units or polyvynilic alcohol segments by polymerization then hydrolysis, or from methacrylamido of 2-imidazolidinone ethyl.

Examples of monomers from which the reticulating units (R) are derived, include, but are not limited to: divinylbenzene, dimethacrylate of ethylene glycol, the allyl methacrylate, methylene bis (acrylamide), and glyoxal bis (acrylamide).

The choice and the relative amount of the monomer or monomers from which the unit(s) (N), (F) and (R) of the polymer (P) are derived are such that the polymer (P) preferably has a Tg of greater than about 25° C., more preferably between about 25° C. and about 150° C., even more preferably between about 25° C. and about 100° C., still more preferably between about 40° C. and about 100° C., most preferably between about 50° C. and about 80° C., and remains non-soluble in the operating conditions of the composition of the present invention. The polymer (P) may alternatively have a Tg of any value in excess of 25° C., or within any narrower ranges that fall within the above ranges (e.g., between about 30 and about 110° C.).

In some embodiments, at least about 70% of the total mass of the polymer (P) is composed of hydrophobic (N) units and optionally not more than about 30% of the total mass of said polymer (P) is composed of hydrophilic (F) units, and less than about 20%, preferably less than about 10%, most preferably less than about 5% of the total mass of the polymer (P) is composed of reticulating units.

The polymer (P) can be obtained by any process known in the art such as radical polymerization of the ethylenically unsaturated monomers in the aqueous medium. Some processes for preparing nanoparticle latexes with small diameter particles are better described in Colloid Polym. Sci. 266:462-469 (1988) and in Journal of Colloid and Interface Science. Vol. 89. No. 1, September 1982, pages 185 and following pages. One mode of preparation of latex with particles having an average size smaller than 100 nm, particularly having an average size between 1 nm and 60 nm, more particularly having an average size between 5 nm and 40 nm is described in European Patent publication EP-A-644,205.

According to the present invention, the polymer (P) is considered as being non-soluble when less than about 15%, preferably less than about 10% of its weight is soluble in the aqueous or humid (moist) medium in which the composition is used at the temperature and pH of the medium.

The pH of the composition preferably ranges between 2 and 12 depending on the intended use. For carpet cleaning compositions, one desirable range of pH is between about 2 and about 6.

Preferred nanolatexes are produced by emulsion polymerization of monomers selected from: methacrylic acid and its salts, alkylmethacrylate, preferably methyl and butyl methacrylate, diMEG, styrene, styrene sulfonic acid and its salts, AMPS. Preferred nanolatexes are based on polystyrene containing AMPS as co-monomer. The nanolatex may, thus, comprise alkylmethacrylate and/or styrene units, optionally carboxylic acid, and/or styrene sulfonic acid functionalities. In some embodiments, the composition is substantially free of malic anhydride copolymers.

Because nanolatexes are produced by emulsion polymerization, surfactants, emulsifiers and other polymerization additives might be present in the compositions according to the present invention as a consequence of the addition of the nanolatex raw material. Among these, surfactants are the most abundant. The surfactants can be present in any suitable concentration. Preferably, the concentration of the surfactant in the final formulations for carpet cleaning is less than about 5% by weight, or any number less than 5%, such as less than or equal to about 4%, 3%, 2%, 1%, or less than or equal to about 0.5% by weight.

Because it is desirable that the composition does not form a film upon water evaporation, nanolatexes with a Tg of greater than about 25° C. are preferred. The composition can also contain blends of high and low (i.e., less than 25° C.) Tg nanolatexes in a ratio that prevents the formation of a film upon water casting at 25° C.

The preferred average particle size of the nanolatex particles is below about 500 nm, preferably below about 300 nm, more preferably between about 20 nm and about 250 nm. The average particle size of the nanolatex particles can fall within other suitable ranges of particle size that fall within the above ranges, including but not limited to from about 10 nm to about 500 nm, more preferably from about 20 nm to about 300 nm, and most preferably from about 20 to about 100 nm.

The nanolatex can be present in any suitable concentration in the compositions. In some embodiments, however, the concentration is preferably between about 0.1 and about 10%, and is preferably less than about 7%, and more preferably is between about 0.5 and about 5%. The concentration of the nanolatex in the composition can also be present below any number or within any range of numbers that falls within the aforementioned ranges of concentration.

The compositions described herein can be formulated as liquid compositions. Preferred compositions herein are aqueous compositions and therefore, preferably comprise water, more preferably in an amount of from 60% to 98%, even more preferably of from 80% to 97% and most preferably 85% to 97% by weight of the total composition.

### Optional Ingredients

The compositions of the present invention may also include various optional ingredients. These include, but are not limited to the following: bleaching agents; chelants and radical scavengers; fluorinated compounds; divalent cations; surfactants; solvents; soil release polymers; perfumes; and brighteners.

A bleaching agent can be used to deliver bleachable stain (especially color stain) removal benefits. Any suitable type of bleaching agent can be used. Suitable bleaching agents include, but are not limited to: peroxygen sources, such as hydrogen peroxide, organic peroxides, preformed peracids and mixtures thereof. One preferred bleach agent is hydrogen peroxide. The bleaching agent can be present in any suitable concentration. In several non-limiting embodiments, peroxygen bleach is present in a concentration between about 0.01% and about 20%, preferably between about 0.01% and about 10%, and most preferably is about 4%. Suitable bleaching agents (and stabilizers therefore) are described in greater detail in EP 0 629 694 B1, published Dec. 21, 1994.

Chelants and radical scavengers can be added as stabilizers for the bleaching agent, i.e., to minimize the Available Oxygen (AvO) loss upon storage of the product. Suitable chelants include, but are not limited to HEDP, EDTA, NTA, and biodegradable chelants such as s,s-ethylene diamino disuccinate and dipicolonic acid.

### Fluorinated Compounds

Fluorinated compounds, or mixtures thereof may be added to the composition to provide an anti-resoiling benefit. Any fluorinated compound known to those skilled in the art providing the benefit of rendering a carpet or other material first cleaned with a composition less prone to soil and thus facilitating next-time cleaning operation (“anti-resoiling performance benefit”) may be used in the compositions employed in the process according to the present invention. The fluorinated compounds used herein may, therefore, be referred to as fluorinated anti-resoiling compounds.

Suitable fluorinated compounds for use herein can be selected from the group consisting of fluoropolymers and fluorosurfactants and mixtures thereof.

Suitable fluoropolymers are polymers or compounds having pendent or end groups of perfluoroalkyl moieties, such as fluorinated polyacrylates; fluorinated polymethacrylates; fluorinated copolymers including acrylic and/or methacrylic and/or maleic monomers; fluorinated urethanes; fluorinated polyurethanes; and mixtures thereof.

In a preferred embodiment according to the present invention, the fluorinated compound is a fluoropolymer. Preferably, the fluorinated compound used herein is a fluorinated polyacrylate, polymethacrylate, urethane or polyurethane.

By “fluorinated polyacrylates” it is meant herein any polymer of acrylic acid carrying pendent or end groups of polyfluoroalkyl moieties. By “fluorinated polymethacrylates” it is meant herein any polymer of methacrylic acid carrying pendent or end groups of polyfluoroalkyl moieties. By “fluorinated copolymers including acrylic and/or methacrylic and/or maleic monomers” it is meant herein any copolymer of acrylic acid and/or methacrylic acid and/or maleic acid carrying pendent or end groups of polyfluoroalkyl moieties.

Preferably, the polyfluoroalkyl moiety is a linear or branched polyfluoroalkyl group having from 1 to 20 carbon atoms, preferably from 1 to 16, even more preferably from 3 to 12. Preferably, the polyfluoroalkyl group according to the above description is a perfluoroalkyl group. Typically, the polyfluoroalkyl moiety has the following structure:

CF₃—(CF₂)ₙ—CH₂—CH₂—

wherein n ranges from 0 to 20, preferably from 1 to 16, more preferably from 2 to 12, even more preferably from 3 to 10, and is esterified with some or all of the carboxylic groups of the fluorinated polyacrylates, fluorinated polymethacrylates or fluorinated copolymers including acrylic and/or methacrylic and/or maleic monomers.

Preferably, the fluorinated polyacrylates, fluorinated polymethacrylates and fluorinated copolymers including acrylic and/or methacrylic and/or maleic monomers have a molecular weight of from 500 to 200,000, more preferably from 1,000 to 150,000, and even more preferably from 1,500 to 100,000.

Suitable fluorinated polyacrylates are commercially available under the trade name Syntran 4010E® from Interpolymer; Asahi Guard AG-7000®, Asahi Guard AG-8095®, and Asahi Guard AG-1100®, all from Asahi Glass Co., Ltd.

By “fluorinated urethanes or polyurethanes” it is meant herein any compound, polymer or copolymer synthesized from at least the following components: 1) a bifunctional or polyfunctional isocyanate; and 2) a compound or monomer containing a polyfluoroalkyl group.

Specific examples of bifunctional isocyanate compounds are aromatic isocyanates such as 2,4-tolylene diisocyanate, tolidine diisocyanate, 4,4′-diphenylmethane diisocyanate, dianisidine diisocyanate, 2-methyl-cyclohexane 1,4-diisocyanate, isophorone diisocyanate, and aliphatic isocyanates such as hexamethylene diisocyanate or decamethylene diisocyanate. If these isocyanates are represented by the general formula OCN—Y—NCO (wherein Y stands for any aromatic or aliphatic group), and if OCN—Y—NCO is reacted by itself in the presence of water, a dimer of formula OCN—Y—NHCONH—Y—NCO will be formed. The bifunctional isocyanate compound includes such a dimer.

Polyfunctional isocyanate compounds include, for example, trifunctional, tetrafunctional and pentafunctional isocyanates. In addition, two or more isocyanate compounds having different bi- or polyfunctionalities may be used in combination in the same fluorinated polyurethane. Specific examples of trifunctional isocyanate compounds are given below. As mentioned above for the bifunctional isocyanate compounds, however, the trifunctional isocyanate compound further includes compounds having tri-NCO groups such as a trimer of formula

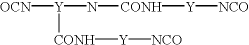

obtainable by reaction of a monomer of formula OCN—Y—NCO with a dimer of the formula OCN—Y—NHCONH—Y—NCO, and a tetramer of formula

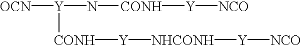

obtainable by reaction of two molecules of such a dimer.

Specific examples of such a trifunctional isocyanate compound include the following compounds:

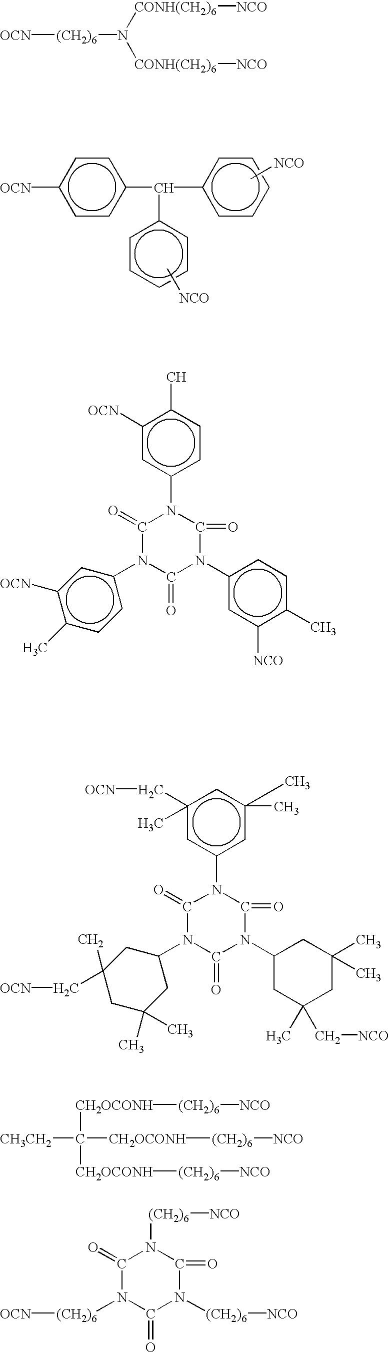

Specific examples of monomers or compounds containing a polyfluoroalkyl group are according to the following formulae:

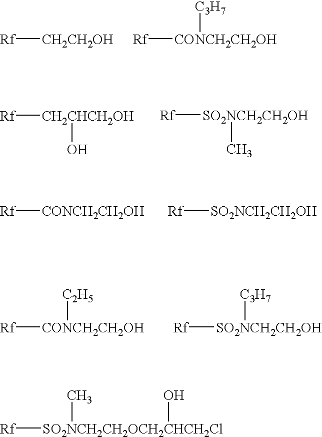

wherein Rf is a linear or branched polyfluoroalkyl group having from 1 to 20 carbon atoms, preferably from 2 to 16, even more preferably from 3 to 12. Other examples of monomers or compounds include esters of polyfluoroalkyl alcohols; polyfluoroalkyl amines; and in general any compound that includes a polyfluoroalkyl radical and carries one or more functional groups having one or more Zerewitinoff hydrogen atoms. In the Zerewitinoff et al. method, an active hydrogen-containing organic compound (—OH, —COOH, —NH, etc.) is reacted with a CH₃Mg halide to liberate CH₄ which, measured volumetrically, gives a quantitative estimate of the active hydrogen content of the compound. Primary amines give 1 mol of CH₄ when reacted in the cold; usually two mols when heated (Organic Chemistry by Paul Karrer, English Translation published by Elsevier 1938, page 135).

Two or more different kinds of these compounds may be used in combination. Further, two or more compounds having different carbon numbers for Rf may be used in combination. Preferably, the polyfluoroalkyl group according to the above description is a perfluoroalkyl group.

The fluorinated polyurethanes according to the present invention may also include other monomers, for instance to improve the efficiency of their synthesis, or to impart certain mechanical characteristics to the final material obtained. These additional monomers are described in the prior art, for instance examples are given in EP-A-0 414 155 (Asahi Glass Company LTD).

Fluorinated urethane compounds suitable for the present invention are described also in U.S. Pat. No. 5,565,564 to Du Pont de Nemours and Company.

Suitable fluorinated urethanes or polyurethanes are commercially available for example under the trade name Asahi Guard AG-320A®, Asahi Guard AG-850®, Asahi Guard AG-530N®, all from Asahi Glass Co., Ltd.; and under the trade name Zonyl 1250® from DuPont De Nemours Inc. Suitable fluorinated polymers are also urethane perfluoroalkyl ester compounds such as Zonyl TBCU-A® from DuPont De Nemours Inc.

Suitable fluorosurfactants are, for example, selected from the group consisting of: fluoroalkyl carboxylates; fluoroalkyl sulphates; fluoroalkyl sulphonates; fluoroalkyl phosphates; fluoroalkyl polyethoxyalcohols; fluoroalkyl ammonium; fluoroalkyl betaines or sulphobetaines or other zwitterionic forms; and mixtures thereof.

In a preferred embodiment according to the present invention, the fluorinated compound is a fluorosurfactant. Preferably, the fluorinated compound herein is a fluorosurfactant selected from the group consisting of: fluoroalkyl carboxylates; fluoroalkyl sulphates; fluoroalkyl sulphonates; fluoroalkyl phosphates; fluoroalkyl phosphonates; fluoroalkyl polyethoxyalcohols; fluoroalkyl ammonium; fluoroalkyl betaines or sulphobetaines or other zwitterionic forms; and mixtures thereof.

In a preferred embodiment, the general structure of fluorosurfactants suitable for the present invention is:

Rf—CH₂—CH₂—X

wherein Rf is a linear or branched polyfluoroalkyl group having from 1 to 20 carbon atoms, preferably from 2 to 16, even more preferably from 3 to 12. Preferably, the polyfluoroalkyl group according to the above description is a perfluoroalkyl group. The functional group X can be any of the above listed functional groups, for example —SO₃⁻; —OSO₃⁻; —OPO₃²⁻; —PO₃²⁻; —COO⁻; —O(CH₂CH₂)ₙH, wherein n can range from 1 to 50, preferably from 2 to 20; —N⁺R₁R₂R₃, wherein any of R₁, R₂, R₃ can be a linear or branched saturated or unsaturated alkyl group, or a cycloalkyl group, or an aryl group, or a substituted alkyl or aryl group, preferably an alkyl group and even more preferably a methyl group.

Other preferred fluorosurfactant structures according to the present invention are according to the following formulae:

(R_{f}CH₂CH₂O)ₓPO(O—NH₄⁺)_{y}; x+y=3

(R_{f}CH₂CH₂O)ₓPO(O—NH₄⁺)_{y}(OCH₂CH₂OH)_{z}; x+y+z=3

(R_{f}CH₂CH₂O)ₓPO(O—NH₂(CH₂CH₂OH)₂⁺)_{y}; x+y=3

R_{f}CH₂CH₂SCH₂CH₂COO⁻Li⁺

R_{f}CH₂CHO(Ac)CH₂N⁺(CH₃)₂CH₂COO⁻

(^{-OOC)x(R}_{f}CH₂CH₂OOC)_{y}C₃H₅O(Citrate); x+y=3

wherein Rf is a linear or branched polyfluoroalkyl group having from 1 to 20 carbon atoms, preferably from 2 to 16, even more preferably from 3 to 12.

Typical countercations for anionic functional groups of fluorosurfactants according to the present invention are H⁺ or a metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typical counteranions for cationic functional groups of fluorosurfactants according to the present invention are, for example, chloride, fluoride, bromide, sulphate, nitrate, mesilate, acetate, citrate and the like. Any countercation and counteranion that does not have a negative impact on the ant-iresoiling properties of the fluorosurfactants according to the present invention may be used.

Suitable fluorosurfactants are commercially available for example under the trade name Zonyl FSP®, Zonyl FSE®, Zonyl FSJ®, Zonyl NF®, Zonyl TBS®, Zonyl FS-62®, Zonyl FSA®, Zonyl FSK®, Zonyl 7950®, Zonyl 9075®, Zonyl FSO®, Zonyl FSN®, Zonyl FS-300®, Zonyl FS-310®, Zonyl FSN-100®, Zonyl FSO-100®, all available from DuPont De Nemours Inc.; Fluorad® fluorosurfactants from 3M Inc.; Surflon® fluorosurfactants from Asahi Glass Co., Ltd.

Typically, the liquid compositions herein comprise from about 0.0001% to about 10%, preferably from about 0.0005% to about 7%, more preferably from about 0.001% to about 5%, and even more preferably from about 0.001% to about 1%, and most preferably from about 0.01% to about 0.5% by weight of the total composition of a fluorinated compound or a mixture thereof. Typical combinations of nanolatex and fluorinated compounds are those in which the weight ratio between the nanolatex and the fluorinated compound is between about 100:1 and about 1:1, more preferably between about 80:1 and about 2:1, even more preferably between about 40:1 and about 5:1, and most preferably between about 30:1 and about 10:1.

Divalent cations can bridge separate nanolatex particles during water casting favoring the formation of easy to vacuum polymer aggregates. Divalent cations such as Ca2+, Mg2+ and Zn2+ having an inorganic counterion, such as sulfate, chloride, nitrate, phosphate etc. Any suitable concentration of the diavalent cations can be used. The concentration of the divalent cations is preferably low enough to prevent a significant agglomeration of the nanolatex particles in the formulation. One suitable concentration of the divalent cations is between about 1×10⁻⁸M and about 1×10⁻²M.

Surfactants can be used for cleaning, particularly greasy soil cleaning. Suitable surfactants can include anionic, cationic, nonionic and zwitterionic surfactants. Preferred surfactants are the anionic ones. Some preferred anionic surfactants are alkaline hearth salts of alkyl sulfate and benzene alkyl sulfonate, with the alkyl chain being linear or branched and containing between about 2 and about 30 carbon atoms, more preferably between about 5 and about 20 and even more preferably between 10 and 18. In some embodiments, the composition is preferably substantially free of glycoside surfactants.

When the composition is to be applied by spraying, the surfactants are preferably non-irritating to the user. In such embodiments, the composition may comprise a nonirritating anionic surfactant that is rated nonirritating to the mucous membranes of the person spraying the composition as measured at a 5% active surfactant solution using the Draize test method. The Draize test method (Draize, J. H., Appraisal of the Safety of Chemicals in Foods, Drugs and Cosmetics, Assoc. Food Drug Officials, U.S., Topeka, Kans., 1959) is used to test ingredients (such as surfactants) in food, drug and/or cosmetic products for their irritation properties to skin, eyes, mucous membranes and the like.

Suitable non-irritating anionic surfactants can be selected from the group consisting of sarcosinate surfactants, sulfosuccinate surfactants, alkyl sulphonate surfactants, alkyl sulphate surfactants, sulfosuccinamate surfactants, sulfosuccinamide surfactants, carboxylate surfactants and mixtures thereof. Preferably, said non-irritating anionic surfactants are selected from the group consisting of sarcosinate surfactants sulfosuccinate surfactants, alkyl sulphonate surfactants, alkyl sulphate surfactants, carboxylate surfactants and mixtures thereof. More preferably, the non-irritating anionic surfactants are selected from the group consisting of sarcosinate surfactants, sulfosuccinate surfactants, alkyl sulphonate surfactants, alkyl sulphate surfactants and mixtures thereof. Even more preferably, the nonirritating anionic surfactants are selected from the group consisting of sulfosuccinate surfactants, alkyl sulphate surfactants, alkyl sulphonate surfactants and mixtures thereof. Most preferably, the non-irritating anionic surfactants are selected from the group consisting of sulfosuccinate surfactants, alkyl sulphate surfactants and mixtures thereof. Non-irritating surfactants preferred for use in sprayable compositions are described in greater detail in European Patent Publication EP 01 059 349 A1, published Dec. 13, 2000.

The surfactants can be present in any suitable concentration. It has been found, however, that providing a composition with too high a level of sufactant can lead to problems. Increasing the level of surfactant can lower the minimal film forming temperature of the composition, resulting in the formation of films which are more difficult to remove by vacuuming. In certain embodiments, therefore, the level of surfactant is less than about 5%. In other embodiments, the surfactant can be present at any numerical level that is less than 5% (e.g., 4.5%, 4%, . . . , 1%, etc.).

The composition may also include volatile solvents. Preferably, the volatile solvents used herein have a boiling point below about 50° C. Suitable volatile solvents include, but are not limited to MeOH, EtOH, and isopropyl alcohol. The volatile solvents can be present in any suitable concentration. In one embodiment, the volatile solvents are included at a concentration of less than about 5%. Suitable volatile organic solvents are described in greater detail in European Patent Application EP 0 949 325 A1, published October 13, 1999.

Suitable soil suspending polymers include polycarboxylate or polyamine polymers. Such soil suspending polymers are described in greater detail in European Patent Publication EP 0 751 213 A1, published Jan. 2, 1997 (U.S. Pat. No. 5,905,065 issued to Scialla, et al. on May 18, 1999).

The compositions of the present invention are preferably substantially free of certain ingredients, such as pigments.

### Methods of Cleaning Carpets and Other Materials

The present invention also relates to methods of cleaning carpets and other materials. In the case of carpets, the methods comprise the steps of:

(a) locating a carpet;

(b) applying the carpet cleaning compositions described herein to at least a portion of said carpet, said carpet cleaning composition comprising a nanolatex material and water; and

(c) allowing the carpet cleaning composition to dry.

The method may also comprise a step of vacuuming the carpet. Steps (a) to (c) can be repeated one or more times before vacuuming.

The composition can be applied to the carpet in any suitable manner. Preferably, the composition is applied by a sprayer, more preferably by a trigger or pump sprayer and even more preferably by an electrical sprayer, wherein the electrical sprayer can be battery or power operated.

In one non-limiting embodiment, the droplet size distribution of the sprayed composition has an average value greater than or equal to about 200 nm, more preferably greater than or equal to about 400 nm. It has been found that, while smaller size droplets may be preferred for wool carpets when the composition contains peroxide, the aforementioned droplet sizes are preferred for use on both wool and nylon carpets, particularly in the case of peroxide-free compositions.

### EXAMPLES OF COMPOSITIONS

| Nanolatex characteristics | | | | | | | | | | | |
|---|---|---|---|---|---|---|---|---|---|---|---|
| Monomer composition⁺ | | | | | | | Composition | | | | |
| MA | AMPS | MMA | BuA | Styr | size | Tg | | Conc. | Soil removal performance index* | | |
| % w/w | % w/w | % w/w | % w/w | % w/w | nm | ° C. | pH | % w/w | Silicon | Iron | Aluminum |
| | | 65 | 35 | | 27 | 46 | 4 | 3 | 1 | 5 | 5 |
| 5 | | 95 | | | 88 | | 9 | 3 | 12 | 1 | 17 |
| 5 | | 95 | | | 88 | | 9 | 3 | 18 | na | 19 |
| 5 | | 95 | | | 88 | | 4 | 3 | 6 | 4 | 5 |
| 5 | | 95 | | | 240 | 126 | 9 | 3 | 36 | 4 | 29 |
| 99 | 1 | | | | 74 | 112 | 4 | 3 | 2 | 0 | 2 |
| 99 | 1 | | | | 114 | 120 | 4 | 3 | 0 | 0 | 0 |
| 99 | 1 | | | | 256 | 118 | 4 | 3 | 20 | 0 | 0 |
| | | | | 100 | 40 | 108 | 4 | 3 | 4 | 4 | 0 |

+MA = methacrylic acid
AMPS = 1-Propanesulfonic acid, 2-methyl-2-[(1-oxo-2-propenyl)amino]- (9CI)
MMA = methyl methacrylate
BuA = Butyl acrylate
Styr = Styrene
% w/w—refers to weight percentage.
*calculated as [(Element_{vacuum} − Elementₙₐₙₒₗₐₜₑₓ) × 100/Element_{vacuum}] where Element is the concentration of Silicon, Iron or Aluminum containing soil measured directly on the carpet by X-ray fluorescence. The higher the soil removal performance index, the more soil is removed due to the application of the nanolatex containing formulation.

The compositions are made by combining the ingredients in the listed proportions. Thus, for example, the first composition will comprise a combination of nanolatexes comprising 65% by weight methyl methacrylate and 35% by weight of butyl acrylate. This nanolatex composition will be diluted with water to form a carpet cleaning composition comprising 3% of this nanolatex composition and 97% water.

Without wishing to be bound by any particular theory, it is believed that water based formulations for carpet cleaning based on nanolatexes which do not form a film, but aggregates upon water casting are easily removed by vacuuming especially if compared to film forming polymers delivered as aqueous solutions.

Film forming polymers, such as polymethacrylic acid form brittle, but thin films, whereas non-film forming nanolatexes form thicker aggregates. When sprayed on a nylon carpet surface, the removal by vacuuming of the polymethacrylic acid composition ranges between about 25 and about 50% by weight, whereas the one of the nanolatex composition ranges between about 40 and about 80% by weight.

The compositions described herein provide a number of benefits for cleaning carpets and fabrics. Without wishing to be bound by any particular theory, when the water in the composition evaporates, the nanolatex forms a composite with the soil in the carpet and entraps particulate soils. The surfactant is useful in removing greasy soils from the carpets and fabrics. The peroxygen bleach is effective for removing color stains from the carpets and fabrics.

The disclosure of all patents, patent applications (and any patents which issue thereon, as well as any corresponding published foreign patent applications), and publications mentioned throughout this description are hereby incorporated by reference herein. It is expressly,not admitted, however, that any of the documents incorporated by reference herein teach or disclose the present invention.

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. An aqueous carpet cleaning composition comprising:
a nanolatex polymer;
a source of peroxygen bleach; and
water, wherein said nanolatex polymer forms a suspension in the water.

2. A composition according to claim 1 wherein the Tg of the nanolatex polymer is greater than about 25° C.

3. A composition according to claim 1 wherein the nanolatex polymer comprises a plurality of particles with an average particle size of less than or equal to about 500 nm.

4. An aqueous carpet cleaning composition according to claim 1 wherein said peroxygen bleach is selected from the group consisting of: hydrogen peroxide; water soluble sources of hydrogen peroxide; organic or inorganic peracids; hydroperoxides; and diacyl peroxides; and mixtures thereof.

5. An aqueous carpet cleaning composition comprising:
a nanolatex polymer;
a fluorinated compound; and
water, wherein said nanolatex polymer forms a suspension in the water.

6. A composition according to claim 5 wherein the Tg of the nanolatex polymer is greater than about 25° C.

7. A composition according to claim 5 wherein the nanolatex polymer comprises a plurality of particles with an average particle size of less than or equal to about 500 nm.

8. An aqueous carpet cleaning composition according to claim 5 wherein said fluorinated compound is selected from the group consisting of fluoropolymers and fluorosurfactants and mixtures thereof.

9. An aqueous carpet cleaning composition according to claim 5 wherein said fluoropolymers are polymers or compounds having pendent or end groups of perfluoroalkyl moieties, and said fluoropolymers are selected from the group consisting of: fluorinated polyacrylates; fluorinated polymethacrylates; fluorinated copolymers including acrylic and/or methacrylic and/or maleic monomers; fluorinated urethanes; fluorinated polyurethanes; and mixtures thereof.

10. An aqueous carpet cleaning composition according to claim 8 wherein said fluorosurfactants are selected from the group consisting of: fluoroalkyl carboxylates; fluoroalkyl sulphates; fluoroalkyl sulphonates; fluoroalkyl phosphates; fluoroalkyl phosphonates; fluoroalkyl polyethoxyalcohols; fluoroalkyl ammonium; fluoroalkyl betaines or sulphobetaines or other zwitterionic forms; and mixtures thereof.

11. An aqeous carpet cleaning composition according to claim 5 wherein said liquid composition comprises from about 0.0001% to about 10% by weight of the total composition of said fluorinated compound or a mixture thereof.

12. An aqueous carpet cleaning composition according to claim 5 wherein the weight ratio between the nanolatex and the fluorinated compound is between about 100:1 and about 1:1.

13. An aqueous carpet cleaning composition according to claim 5 wherein said composition further comprises a peroxygen bleach.

14. An aqueous carpet cleaning composition according to claim 13 wherein said composition comprises from about 0.01% to about 20% by weight of the total composition of said peroxygen bleach.

15. A composition according to claim 1 wherein nanolatex polymer comprises:
hydrophobic monomers “units” (N) that are uncharged or non-ionizable at the pH of said composition in normal conditions of use;
optionally at least one hydrophilic monomer unit (F) chosen from the group consisting of:
(F1) cationic or cationizable monomers at the pH of said composition in normal conditions of use;
(F2) amphoteric monomers at the pH of said composition in normal conditions of use;
(F3) anionic or anionizable monomers at the pH of said composition in normal conditions of use;
(F4) uncharged or non-ionizable hydrophilic monomers at the pH of said composition in normal conditions of use;
any combination thereof; and
optionally, at least one reticulating unit (R).

16. A composition according to claim 15 wherein said monomer units (N) and (F) are derived from α-β monoethylenically unsaturated monomers and optionally wherein said monomer units (R) are derived from diethylenically unsaturated monomers.

17. A composition according to claim 15 wherein said hydrophobic units (N) are derived from vinylaromatic monomers, (α-β fatty acid alkylester monoethylenically unsaturated, vinylesters or allyl of saturated carboxylic acids, α-β nitriles monoethylenically unsaturated.

18. A composition according to claim 15 wherein the cationic or cationisable hydrophilic units (F1) are derived from N,N(dialkylaminoalkyl)amides of α-β carboxylic acids monoethylenically unsaturated, of α-β aminoesters monoethylenically unsaturated, monomers which are precursors of primary amine functions by hydrolysis.

19. A composition according to claim 15 wherein said amphoteric hydrophilic units (F2) are derived from: N,N-dimethyl-N-methacryloyloxyethyl-N-(3-sulfopropyl) sulfobetaine ammonium, from N,N-dimethyl-N-(2-methacrylamidoethyl)-N-(3-sulfopropyl) betaine ammonium, from 1-vinyl-3-(3-sulfopropyl) betaine imidazolidium, from 1-(3-sulfopropyl)-2-vinylpyridinium betaine, are also derived from the reaction of quaternization of N(dialkylaminoalkyl) amides of α-β carboxylic acids ethylenically unsaturated or from α-βaminoesters monoethylenically unsaturated by a alkali metal chloroacetate or sultone propane chloroacetate.

20. A composition according to claim 15 wherein said hydrophilic anionic or anionisable (F3) units are derived from α-βmonomers monoethylenically unsaturated having at least one carboxylic function, from α-β monomers monoethylenically unsaturated having at least one sulfate or sulfonate function, (α-β monomers monoethylenically unsaturated having at least one phosphonate or phosphate function, and their hydrosoluble salts, from α-β monomers monoethylenically unsaturated being precursors of carboxylate function(s) by hydrolysis.

21. A composition according to claim 15 wherein said hydrophilic uncharged or non-oinizable (F4) units are derived from (α-β hydroxyalkylester acids monoethylenically unsaturated, from (α-β amide acids monoethylenically unsaturated, from α-β monomers ethylenically unsaturated carrying a hydrosoluble polyoxyalkylened segment, from α-β monomers monoethylenically unsaturated being precursors of vinylic alcohol units or polyvynilic alcohol segments by polymerization then hydrolysis, or from methacrylamido of 2-imidazolidinone ethyl.

22. A composition according to claim 15 wherein said reticulating unit (R) is derived from divinylbenzene, from ethylene glycol dimethacrylate, from allyl methacrylate, from methylene bis (acrylamide), from glyoxal bis (acrylamide).

23. A composition according to claim 15 wherein the choice and the relative amount of said monomer or monomers from which are derived the unit(s) (N), (F) and (R) of the polymer (P) are such that said polymer (P) has a Tg between about 25° C. and about 150° C., and remains non-soluble in the operating conditions of the composition.

24. A composition according to claim 15 wherein at least about 70% of the total mass of said polymer (P) is composed of hydrophobic (N) units and optionally not more than about 30% of the total mass of said polymer (P) is composed of hydrophilic (F) units, and less than about 20% of the total mass of said polymer (P) is composed of reticulating units.

25. A composition according to claim 24 wherein the cleaning composition comprises at least a nanolatex with at least an uncharged or non-ionisable polymer (P1) comprising:
at least 70% by weight of hydrophobic monomer units (N);
optionally, at least 1%, more preferably between 3% to 30% by weight of uncharged or non-ionisable hydrophilic monomer units (F4); and
optionally, no more than 20% by weight of uncharged or non-ionisable reticulating units (R).

26. A composition according to claim 1 wherein the nanolatex polymer comprises alkylmethacrylate and/or styrene units, optionally carboxylic acid, and/or styrene sulfonic acid functionalities.

27. A cleaning process for cleaning a carpet, said process comprising the following steps:
applying an effective amount of an aqueous cleaning composition according to any of the preceding claims to a carpet wherein said nanolatex polymer is non-soluble in the operating conditions of said process;
drying said carpet so that the water in said composition evaporates and said nanolatex polymer forms a composite product comprising at least some of said polymer and soil; and
optionally eliminating said composite product from said carpet to further clean said carpet.

28. The process of claim 27 wherein said step of applying an aqueous cleaning composition comprises spraying said cleaning composition onto said carpet by a trigger, pump or electrical sprayer, wherein the electrical sprayer is battery or power operated.

29. The process of claim 28 wherein the step of applying an aqueous cleaning composition comprises spraying said carpet cleaning composition onto said carpet with a sprayer that produces a droplet size greater than about 200 nm.
